(19) United States
(12) Patent Application Publication
(10) Pub. No.: US 2003/0093171 A1
(43) Pub. Date: May 15, 2003

(54) Flexible label printing assembly

(75) Inventor: Gregory M. Soehnlen, N. Canton, OH (US)

Correspondence Address: FAY, SHARPE, FAGAN,, MINNICH & McKEE, LLP, 7th Floor, 1100 Superior Avenue, Cleveland, OH, 44114-2516, US

(73) Assignee: Creative Edge Design Group, Ltd.

(21) Appl. No.: 10/199,988

(22) Filed: Jul. 19, 2002

Related U.S. Application Data
(60) Provisional application No. 60/306,625, filed on Jul. 19, 2001.

(51) Int. Cl. G06F 19/00

(52) U.S. Cl. 700/117; 700/216; 700/265; 700/239

(57) ABSTRACT

A high-speed customized product packaging line is enhanced with the inclusion of a high-speed packaging component customizer. The customizer includes a rendering device and a rendering device-compatible rendering information storage device. Rendering information is delivered to the rendering device from the rendering information storage device without additional processing, such as a decompression or image rasterization. Therefore, a production is not delayed due to customizer setup or change over. This enables short custom packaging runs. Methods of producing and distributing products made practical by the production line are also disclosed.

### BACKGROUND OF THE INVENTION

1. Field of the Invention

The present invention is directed to the art of product packaging or labeling in a high-speed product production environment, and more particularly to custom labeling products on a unit-by-unit basis.

The invention will be described in relation to the bottling industry and in particular to labeling in the dairy bottling industry. However, the invention is useful wherever custom or individual product packaging or labeling is desired. For example, the invention is beneficially applied where a product is packaged or labeled under a variety of brands or sizes, such as, for example, a manufacturer brand, and a number of different house brands. Additional benefits are gained from using the invention where customer orders include a variety of brands, sizes, and grades of product. For example, the invention is beneficially applied in the dairy industry where producing milk involves standardizing or mixing various grades of white milk (e.g., skim, 1%, 2%, 3.25% and others) and filling containers, as well as other beverages such as juices, fruit drinks, chocolate milk, into suitable packaging or containers for sale to consumers. The containers are filled with milk and beverages in a sequence dictated by customer orders and distribution routes. The invention makes this process faster and more efficient.

2. Discussion of the Art

Today's dairy industry has made strides in improving the efficiency of processing and filling operations. The focus of these improvements has primarily been in processing and filling speeds, in the handling and storage of large volumes of specific products, and in the order picking and loading processes associated with customer requirement fulfillment.

Examination of the dairy products processing, manufacturing and distribution business (excluding hard cheese) in the United States finds a focus on the white milk segments. Approximately fifty to sixty percent of the product these businesses ship is, by volume, white milk. To a very great extent, this will include white milk with varying milk fat contents of 3.25%, 2%, 1%, ½% and skim (non-fat).

The general process which these businesses follow starts with the receipt of raw milk which is temporarily stored in large tanks prior to processing. Storage in these vessels is limited by law to a maximum time of 72 hours. This milk is then processed into a variety of other products of which the white milk category is the largest segment. In virtually all instances, the next processing step is one of several heat treatment processes defined by the Food and Drug Administration and the Pasteurized Milk Ordinance.

Each type of milk is then processed as a batch and stored in large holding tanks for packaging. These tanks and the processing systems typically are run in the batch mode for long periods of time, limited only by the regulatory agency requirements of cleaning and sanitizing at least once following a 24-hour processing day.

The filling process also occurs with a batch orientation. Generally speaking, the systems are arranged and operated such that individual fillers will draw a particular type of milk from one of the pasteurized storage vessels for a significant period of time. During this time, the filler will run estimated amounts for certain types of customers. In other instances, when an order is provided, exact amounts may be packaged.

In either case, the filler is packaging one product and one label at a time. When a different product is required to pass through the filling process, the system must be evacuated to prevent mixing of products. This results in down time, lost products, and lost packaging, etc.

In addition to product changes, the process requires label changes based on the needs of a specific customer. For example, a dairy may have 2% milk with its own brand and it also may have many other private labels identifying specific customer brands. This implies additional changes, manual intervention on processes and inefficiency. Currently available packaging or labeling devices are optimized for data storage, at the expense of speed. That is, although rendering device manufacturers are concerned with speed to some extent, they are also concerned with reduced memory or data storage costs, As a result, a heretofore unrecognized problem exists in currently available package rendering devices. Prior art packaging rendering devices, such as, for example, label printers, are slower in some respects than they could be. For example, images in known systems are stored in compressed form. When a particular image, such as, for example, a Brand Z, 2%, 1 gallon milk label is to be printed, the image must be called up from compressed storage, uncompressed/decompressed, and transformed to a format that is compatible with associated rendering hardware. For example, a Postscript description of an image must be uncompressed and processed. For instance, the image must under Rasterized Image Processing, or be “RIPed” into a format that is compatible with an ink jet or laser based printing device. The processing consumes a relatively large amount of time. Therefore, systems that may require product labels to be changed on a frequent basis, such as, for example, every few containers or bottles, are slowed undesirably by the prior art packaging rendering devices.

The process of filling batches, attempting to run long batches to avoid excessive product and label changes, and the variability of customer requirements ultimately leads to substantial storage and finished inventory requirements. These inefficiencies have generally led the way for many of the current improvements such as using large automated storage systems to handle long continuous runs, large batches, and large inventory requirements.

Looking at these current businesses from an order fulfillment perspective, it is clear that a variety of categories of requirements exist. Certain businesses have “captive customers” and can “dictate” an order fulfillment process that they currently consider optimal. This may include restrictions on order amounts, carrying inventory at store level, etc. Other businesses have customers who demand flexibility but provide little or no advanced information. These systems require the business to maintain inventory for the customers to assure an available supply, as well as maintain a reasonable level of manufacturing efficiency. Despite the attempts at “just in time” capabilities, none of the current systems have managed to eliminate large and complex material handling systems to handle the processed finished inventories or the inadequacies of the order fulfillment process.

The order fulfillment process includes distribution systems of substantial magnitude and cost. This aspect of current businesses also places demands on the manufacturing and storage processes. Optimization of the entire process has further led to the notion of large buffer storage and ready availability through storage. In virtually all instances, large capital intensive storage facilities and material handling systems have been the apparent solution to the optimization of processing, packaging, order selection, and distribution systems.

The past improvements to or developments for industry problems have focused on individual elements of the order fulfillment process. Instances are available to demonstrate bigger and faster filling machines to reduce the labor cost of packaging. Instances can be shown where expenditures have been made to improve the interface between high-speed manufacturing and complex delivery systems to certain customers. It is apparent that current processing and improvements have not addressed the order fulfillment process as a comprehensive, continuous process.

It would be desirable to develop a beverage processing, labeling, and filling system that effectively meets the requirements of the entire order fulfillment process. This demands a system that eliminates the need for long batch type labeling and filling, large inventory requirements, and complex capital-intensive material handling systems for milk and other beverages.

It would be further desirable to develop a system that would allow for labeling and filling milk and other beverages based on a truck loading and delivery schedule. In order to eliminate or significantly reduce the need for storage, the labeling and filling sequence would print labels and fill various grades and volumes of milk, along with other beverages, and place them on pallets for delivery routing according to the requested order, i.e., products will be produced and made to order at the proper time, speed, and in the exact quantities requirement by distribution for load out. Processing speed is important to such a system. Such a system should not be limited by secondary systems such as package rendering devices or labelers.

### SUMMARY OF THE INVENTION

To those ends a high-speed customer fulfillment based production line has been developed. The production line is operative to produce products in an order that is highly compatible with delivery to a particular customer or series of customers.

The production line includes a high-speed packaging customzer. The packaging customizer comprises a rendering device operative to produce customized product packaging components, an electronic image storage system operative to store custom product package image information in a form that is immediately compatible with the rendering device, and a rendering controller operative to select particular custom product image information from the electronic storage system, based on information delivered from an external source, and deliver the selected custom product image information to the rendering device.

A high-speed method for producing products as an order for products is received comprises the steps of creating a set of customized product packages in a sequence indicated by the order, filling the packages in sequence as indicated by the order, and assembling a shipment corresponding to the order as the sequence of filled product packages is output from the production line.

Some embodiments of the present invention are adapted to the production of milk and dairy products.

One advantage of the present invention is that production is not delayed due to package rendering device setup or changeover.

Another advantage of the present invention resides in the ability to use unique labels or product packages for individual product units without adversely impacting on or slowing overall production.

Yet another advantage of the present invention is found in the ability to use the product package itself to instruct the production line how to fill the package.

Yet another advantage of the present invention is that the processing and filling of milk and other beverage packages is done according to a truck-loading rate based on customer orders.

Yet another advantage of the present invention is found in the dramatic reduction or elimination of inventory. Labor intensive picking and loading steps are reduced; as is the amount of waste due to expired shelf life. Only a small amount of buffer storage is suggested (on the order of 10% of the current inventory).

Yet another advantage of the present invention is the capability of integrating the processing with grocery and food service distribution centers. The truckload can contain the grocery or retail store's order for various products including milk. In the past, milk orders have been delivered to stores separately from other grocery items, directly from the dairy instead of the grocery distribution or warehousing centers.

In addition, order lead time from the customer is based on truck departure/loading time. Orders can arrive minutes before loading, be inserted into the filling queue and then be processed. This aids in minimizing inventories at the storage level.

Packaging is done according to incoming orders.

Still other advantages and benefits of the invention will become apparent to those skilled in the art upon a reading and understanding of the following detailed description.

### BRIEF DESCRIPTION OF THE DRAWINGS

The invention may take form in various components and arrangements of components, and in various steps and arrangements of steps. The drawings are only for purposes of illustrating preferred embodiments, they are not to scale, and are not to be construed as limiting the invention.

FIG. 1 is a general flow diagram that presents an overview of a flexible filling process in accordance with the present invention.

FIG. 2 is a flow diagram representing the flexible filler in accordance with the present invention.

FIG. 3 illustrates the “print and apply” flexible labeling process in accordance with the present invention.

FIG. 4 is a block diagram of a product package customizer.

FIG. 5 is a block diagram of a prior art product package customizer.

FIG. 6 is a plan view of a flexible filler in accordance with the present invention.

FIG. 7 schematically shows the integration of the flexible manufacturing system into the distribution process in accordance with the present invention.

FIG. 8 is a schematic representation of the flexible manufacturing process integrated into the plant supervisory control system in accordance with the present invention.

FIG. 9 (FIGS. 9A and 9B) depicts a typical display in a retail store and the factors affecting replenishment.

FIG. 10 (FIGS. 10A and 10B) illustrates how a customer order is translated to the configuration requirements for pallets of finished product.

FIG. 11 lists a typical customer order broken down into pallet configurations.

FIG. 12 is a flow diagram outlining a method for producing and shipping customized product packages.

FIG. 13 is a flow diagram representing the simplification achieved by the flexible manufacturing process in accordance with the present invention.

FIG. 14 illustrates the conventional method for the milk supply chain from the farm to the store.

FIG. 15 shows the simplified milk supply chain from the farm to the store in accordance with the present invention.

FIG. 16 is a plan view of a micro dairy facility in accordance with the present invention.

FIG. 17 illustrates how a micro dairy might be integrated with an existing distribution facility in accordance with the present invention.

### DETAILED DESCRIPTION OF THE INVENTION

Reference will be made to the drawings which illustrate the present invention in the environment of a dairy that allows the manufacturer or dairy to package liquid products in a manner that optimizes the order fulfillment process. The products are produced only when they are required and only to satisfy a customer order, and not before. Products will be produced in the quantity requirements and at the rate required to load them onto a delivery vehicle for a customer. The result is a much simpler manufacturing process, greatly reduced inventory levels, a dramatically lower total manufacturing cost, and a low distribution cost.

The manufacturing system of the present invention is based on delivery system requirements. This anticipates the most effective delivery system and the manufacturing systems to effectively supply it. If the delivery system demands variable rates of loading, variable numbers of vehicles being loaded at a given time, and variable pallet configurations, all are available to maintain the delivery and customer requirements. The system also utilizes the standard bottles that allow for other products to be stacked on top of the product, which in turn maximizes the delivery process.

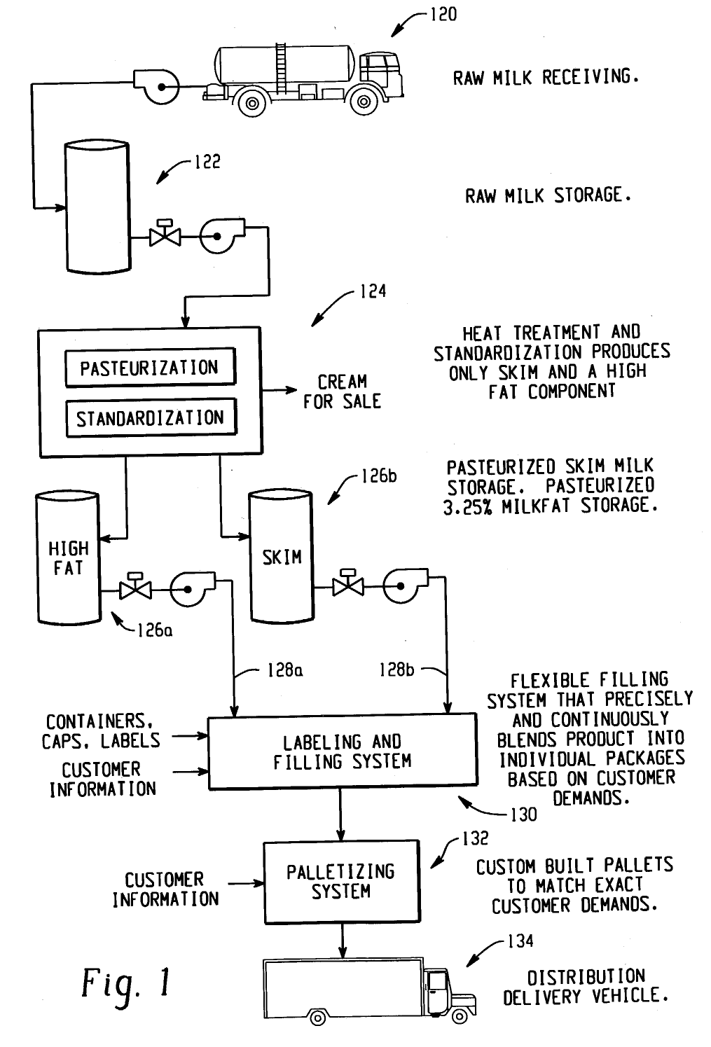

FIG. 1 is a flow chart that describes the basic process utilizing the current invention. Milk is received, for example, by a truck 120, stored in a raw milk storage silo or tank(s) 122, processed by conventional or new technologies as represented at 124, and is standardized to a non-fat or a skim component and to a high fat (3.25% fat or above) component. These individual products are stored in separate pasteurized storage vessels 126a and 126b. Separate supply lines 128a and 128b extend from each vessel to transfer the product to a filling system 130. The filling system, with information from the customer information system, labels and fills bottles or containers exactly to meet the customer requirements. The products are then palletized as referenced at 132 and loaded at 134 directly onto an available delivery vehicle or truck.

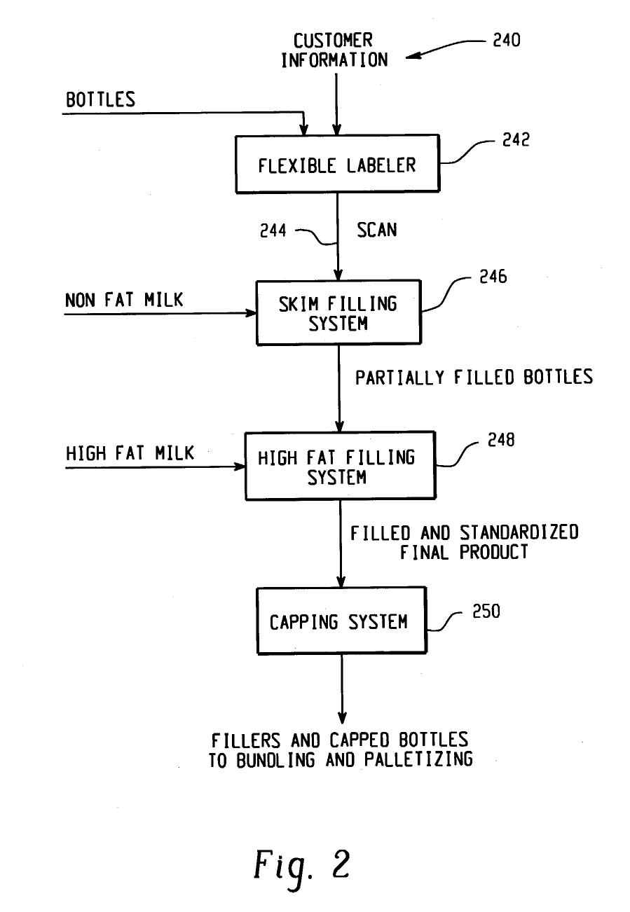

FIG. 2 provides a general flowchart of the filling system of the present invention. This system has customer information or requirements in terms of product type, brand name, ingredient information, nutritional information, color requirements and in many cases specific label requirements that are input at 240. A label is printed in the appropriate sequence at a flexible labeler 242 (to be described in further detail below), and is applied to the bottle as it passes through the label application device. The information on the label includes a UPC (Uniform Product Code) barcode which is scanned at 244 and product type is identified. Other means to identify the bottle could also be used, such as optical character recognition and vision systems. A control system 246 for skim filling dispenses the appropriate amount of skim milk into the bottle. The bottle proceeds next to the high fat filling system 248. This system dispenses the appropriate amount of high fat product into the bottle. The bottle moves to a capping station 250 and then to the bundling and palletizing units.

Varying types of milk are mixed directly in containers by filling calculated weights of skim and high fat milk. For example, a 3-liter bottle filled with milk weighs approximately 3,000 grams. With the approximate weight in mind, the appropriate “X” and “Y” values (wherein X is a weight of skim milk and Y is the weight of 3.25% milk) for the various products are as follows:

| Final Product | X grams | Y grams |
|---|---|---|
| Skim | 3000 | 0 |
| 1% | 2110 | 891 |
| 2% | 1172 | 1828 |
| 3.25% | 0 | 3000 |

The filling equipment is programmed with the weights of the various milk grades and volumes. The container moves through the system, and the appropriate weight portion of milk is directed therein.

The containers are filled using a filling valve or orifice. During operation, the container is filled to a predetermined amount. Generally, this amount corresponds to a final desired content based on weight, volume, depth or other measure. A sensor of the desired measure provides feedback to the filling orifice. The feedback signals the orifice to close. This stops the flow into the container. For example, in the case where the fill is based on weight, a scale will send a feedback signal to the filling orifice to close the valve once the desired weight is achieved. Of course other sensors that are based on different measurable parameters can be used without departing from the scope and intent of the present invention.

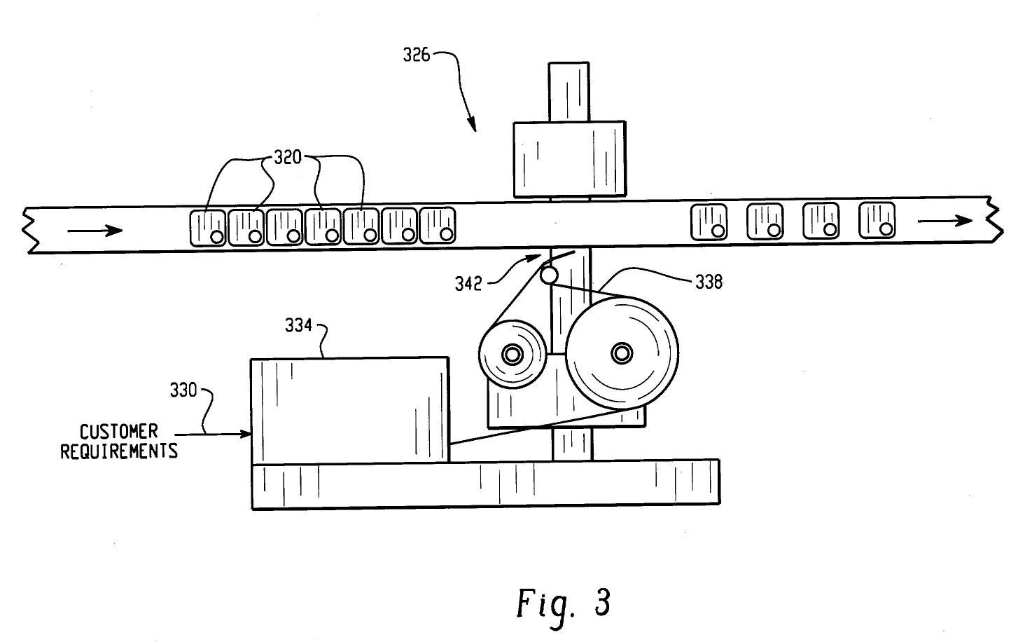

FIG. 3 illustrates an overview of the labeling process. Unlabeled and appropriately oriented bottles 320 enter a label application device 326. As the unlabeled bottle enters the applicator, customer requirement information 330 directs the label printing unit 334 to print a specific label or a specific sequence of labels, as has been determined by customer and delivery optimization requirements. For example, the label-printing unit 334 is directed to print (and apply) ten “Brand X” 2% labels, fifteen “Brand Y” 2% labels, thirty “Brand Z” 2% labels and fifty “Brand Z” skim milk labels. The printer discharges a stream of labels 338, which are conveyed to the label applicator 342.

Alternatively, another package rendering device is substituted for the labeler. For example, a box or carton renderer receives blank container stock and receives information indicating which image to print on the stock and/or perhaps how to cut, fold and/or glue the stock. The carton render then creates custom cartons for a particular customer's order based on this information.

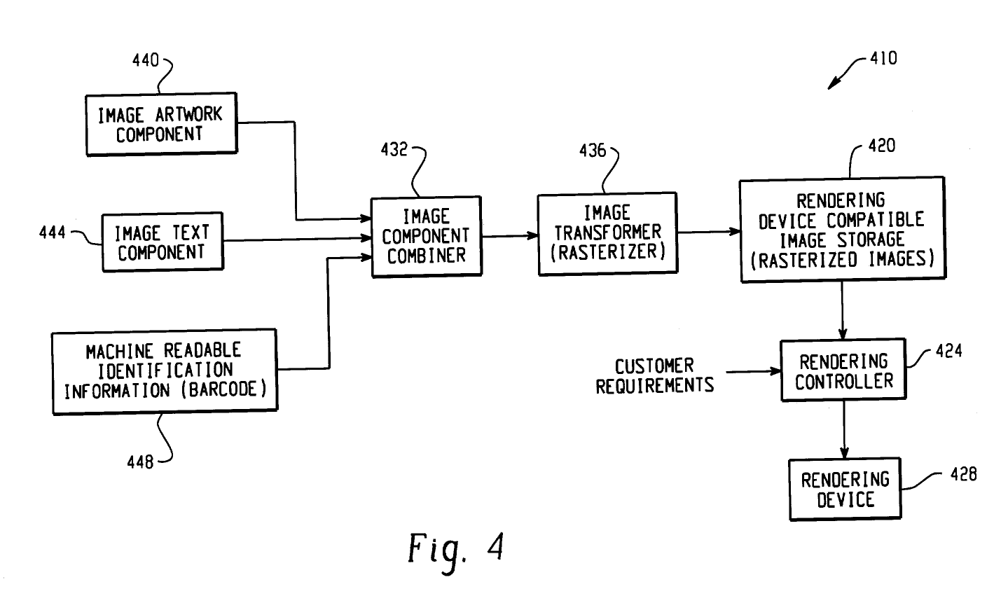

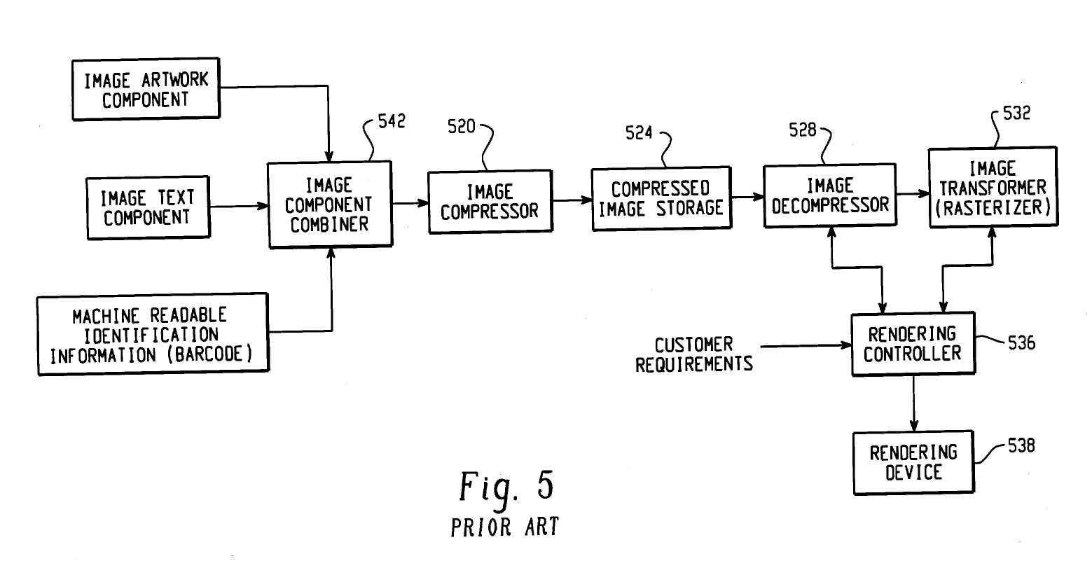

Referring to FIG. 4, a speed optimized package component rendering system 410 includes a rendering device compatible image storage device 420, a rendering controller 424, and a rendering device 428. Additionally, the package component rendering system 410 includes an image component combiner 432 and an image transformer 436. The rendering device compatible image storage device 420 can be any electronic data storage mechanism. Preferably, the storage mechanism has a relatively fast access time. For example, the data storage mechanism comprises non-volatile memory, such as, for example, FLASH memory. Alternatively, the data storage mechanism is implemented in a bulk storage medium such as a computer hard drive or a CD-ROM. Label or package images are stored in the rendering device compatible image storage device 420 in whatever format is most immediately compatible with the rendering device 428. There is little or preferably, no data processing involved in delivering image data to the rendering device 428. For example, where the rendering device is an ink jet based or toner based printer, image data is stored in the rendering device compatible image storage device 420 in a pre-rasterized or pre-RIPed format. Therefore, when customer requirement information 438 delivered, for example, to the rendering controller 424 by, for example a supervisory system (not shown), indicates that a particular image is needed for printing, the rendering controller 424 simply reads the associated image data from the storage device 420 and transmits the image data to the rendering device 428. In this way image setup or change over time is minimized and the package component rendering system 410 is optimized for custom packaging, even on a unit-by-unit basis.

When included in the package component rendering system 401, the image component combiner 432 is used to create and edit packaging images. For example, the image component combiner 432 is an image or package component authoring tool that combines or creates components of a packaging image. For instance, an image artwork or decorative component 440 is created or loaded in the image component combiner. An image text component 444, such as, for example, a product name, brand name, package size or amount, and nutritional information is loaded or created in the image component combiner 432 and added to or combined with the image artwork component 440. Additionally, a machine readable identification component 448 may be loaded into or created in the image component combiner 432. For example, a UPC bar code image is loaded into the image combiner 432. The image combiner is then used to combine the various image components to create a final product package image. The final product image is delivered to the image transformer 436. The image transformer creates a rendering device compatible version of the image. The rendering device compatible version of the image is then stored in the rendering device compatible image storage device 420, along with other rendering device compatible packaging component images. For example, the image transformer is a rasterizer operative to transform Postscript image descriptions into rasterized images that are compatible with ink jet or laser based rendering devices or printers.

Referring to FIG. 5, by contrast a prior art package component rendering system 510 includes an image compressor 520, compressed image storage device 524, and image decompressor 530, in addition to an image transformer 532, rendering controller 536, rendering device 538, and an image combiner 542. Typically prior art package component rendering devices are concerned with saving image storage space. Consequently the image compressor 520 receives an image from the image combiner 542 and applies image data compression techniques to reduce the amount of storage space required to store the image. The compressed version of the packaging image is stored in the space limited, compressed image storage device 524. When the image is needed to generate packaging components such as, for example, cartons or labels, the image is retrieved from the compressed image storage device 524 and processed by the image decompressor 528. For example, the image decompressor 528 restores the image to the original format of the image. Subsequently, the image transformer 532 converts the image into a format that is compatible with the rendering device 538. The rendering controller 536 request the image from, for example, the image decompressor 528, based on customer requirement information that the rendering controller 536 receives from, for example, a supervisory system (not shown), and receives the image from the image transformer 532. The rendering controller 536 then delivers the image to the rendering device 538. Each of the image preparation blocks or steps 528, 532 consumes valuable time. While a packaging component image is being prepared, a product production line must stop or slow down to allow the prior art package component rendering system 510 to setup or change over to the desired image.

In the speed optimized package component rendering system 410 image preparation blocks comparable to image preparation block or steps 528, 532 are not required. Therefore, image setup or change over time is drastically reduced and the production line does not have to stop or slow down. Therefore, frequent packaging component changes, such as, for example, label or carton changes are easily accommodated and custom product production per customer order is readily achieved.

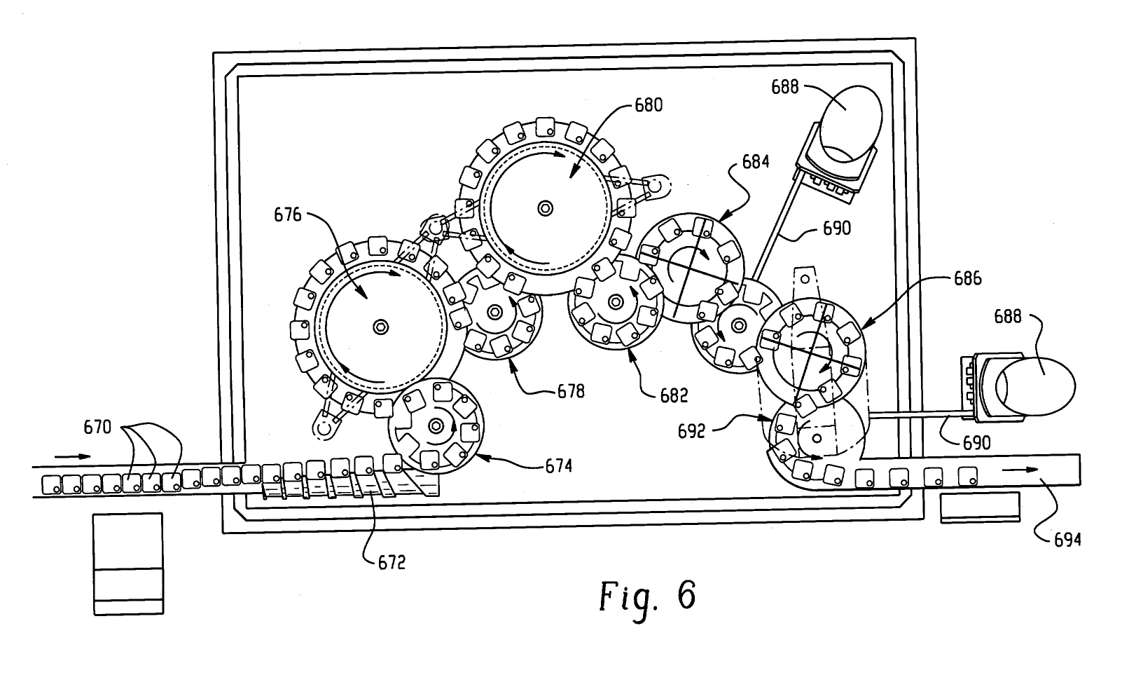

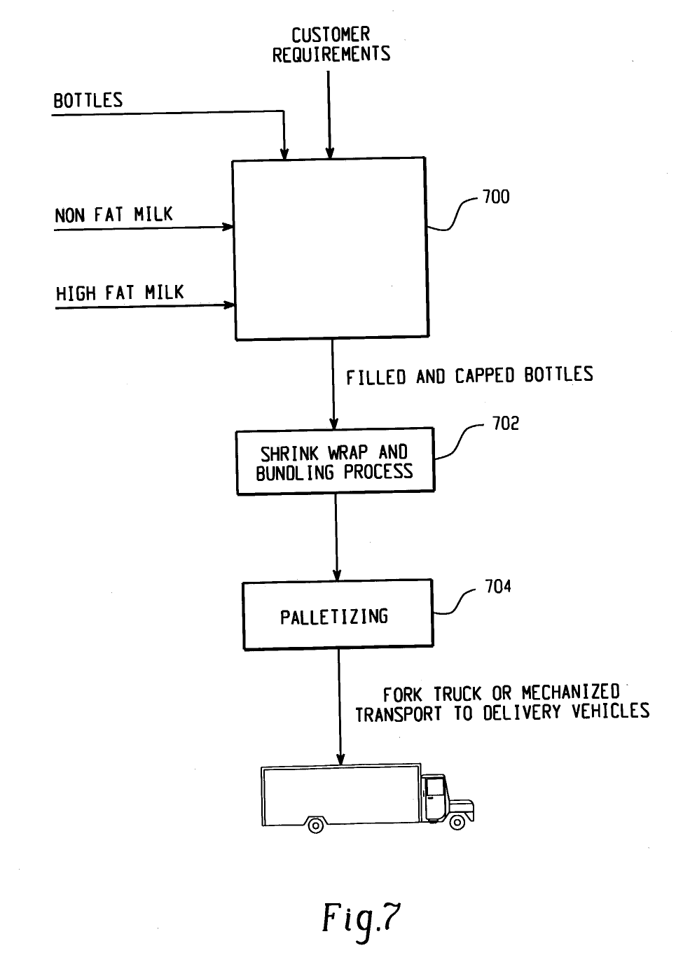

FIG. 6 is a diagram of the actual flexible filling process as it would occur on a Serac filler modified to incorporate two filling bowls in accordance with the present invention. The oriented bottle 670 enters the filler and is metered into the first transfer turret by a metering screw 672. At this point, the label on the bottle is scanned for the information that identifies the product to be filled. The label information allows the filling system to access the exact product information for this particular package or bottle from the control system for the filling process. A first transfer turret 674 locates the bottle under the nonfat milk fill system 676 and onto a platform containing a load cell. This load cell and the control system of the filler act to measure a predetermined amount of the nonfat milk into the bottle. When the bottle is secure on the filler turret 676, the control system opens the valve to allow product to flow into the bottle until the exact amount is entered. The control system then shuts the fill valve and the bottle is transferred from the nonfat fill turret via a second transfer turret 678 to a high fat milk fill turret 680. The control system and platform load cell system associated with the high fat fill system adds the final amount of high fat milk to the bottle. The filled bottle containing the standardized product is removed from the high fat fill turret by a third transfer turret 682. This turret transfers the filled and standardized product bottle to preliminary and final capping stations 684, 686, respectively. These stations may use conventional capping techniques or may use additional techniques receiving caps or pour inserts from hoppers 88 through feed lines 690 to provide added features to the package. An additional transfer turret 92 transfers the finished product from the filler to a discharge conveyor 694, which in turn carries the product to the bundling and palletizing areas.

FIG. 7 conceptually illustrates the integration of this flexible manufacturing system into a distribution process. The manufacturing cell 700 (substantially as described above), operating and responding to the customer requirement information system, discharges filled and closed product (bottles) to a wrapping/bundling system 702 in a sequence that exactly matches the distribution requirements and the customer requirements as needed for consumer satisfaction and optional operational efficiency. Without losing the predetermined sequence, the products are palletized at station 704 to provide a specific pallet with a predetermined mixture of nonfat, 1/2%, 1%, 2% or 3.25% product on each layer. Each pallet may also have a varying number of layers. For example, one pallet may only have three layers and a third pallet may have four layers. The final determination is based on the optimization of the customer requirements and distribution processes. For example, product leaves the production line in a sequence that allows a pallet to be loaded in an arrangement that is convenient for pallet unloading into a supermarket display case.

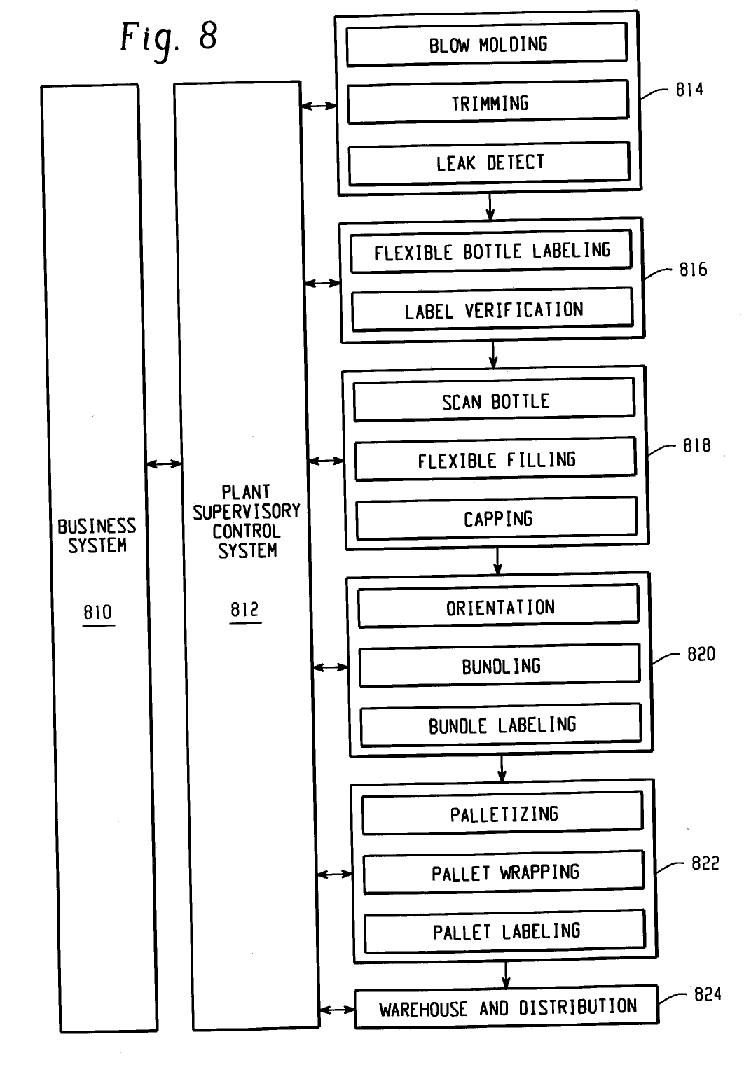

The application of the present invention to meet the order fulfillment requirements of the dairy industry's operations has been illustrated in FIG. 8. This illustrates the control and operation of this flexible manufacturing approach in a more fully integrated environment. The customer information, which is part of the business system information 810, is supplied to a supervisory control system 812. This control system maintains and directs a bottle making system and process 814, labeling system and process 816, the filling and capping system and process 818, the bundling system and process 820, and the palletizing system and process 822. Additionally, the system monitors the process to ensure proper sequence is maintained and provides a coordinated label printing for the completed pallet prior to the issuance to delivery system 824. The supervisory control system is in constant communication with the business control system. The result is that prioritized information is supplied to the supervisory control enabling the coordination of completed pallets that exactly match the priorities of loading and delivery schedules. This is all achieved with virtually no inventories of empty bottles, of preprinted labels, finished or pre-packaged product inventories, and standard palletizing or product configurations that force unnecessary and undesirable constraints on distribution or customers.

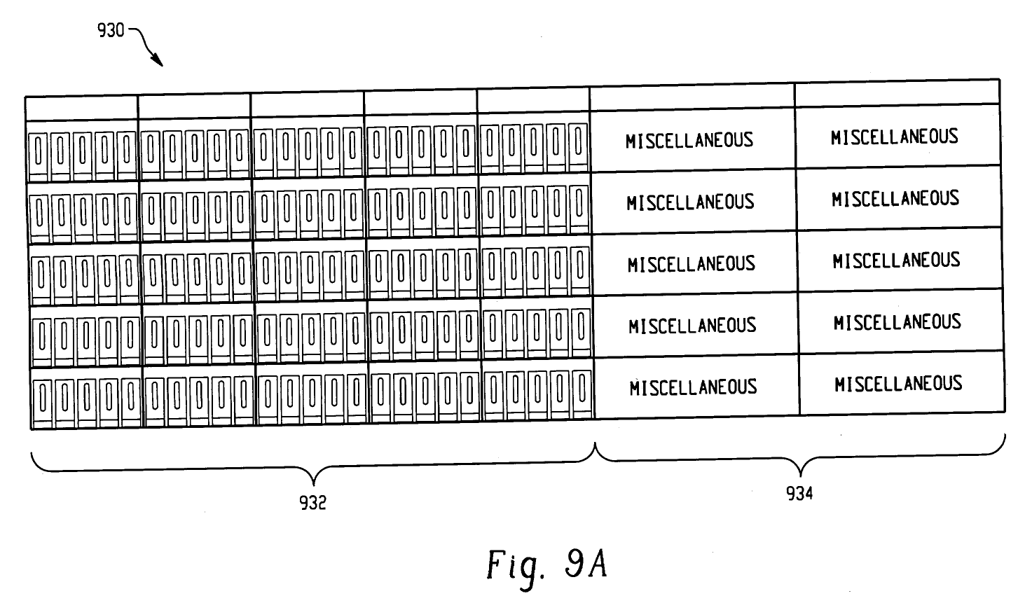

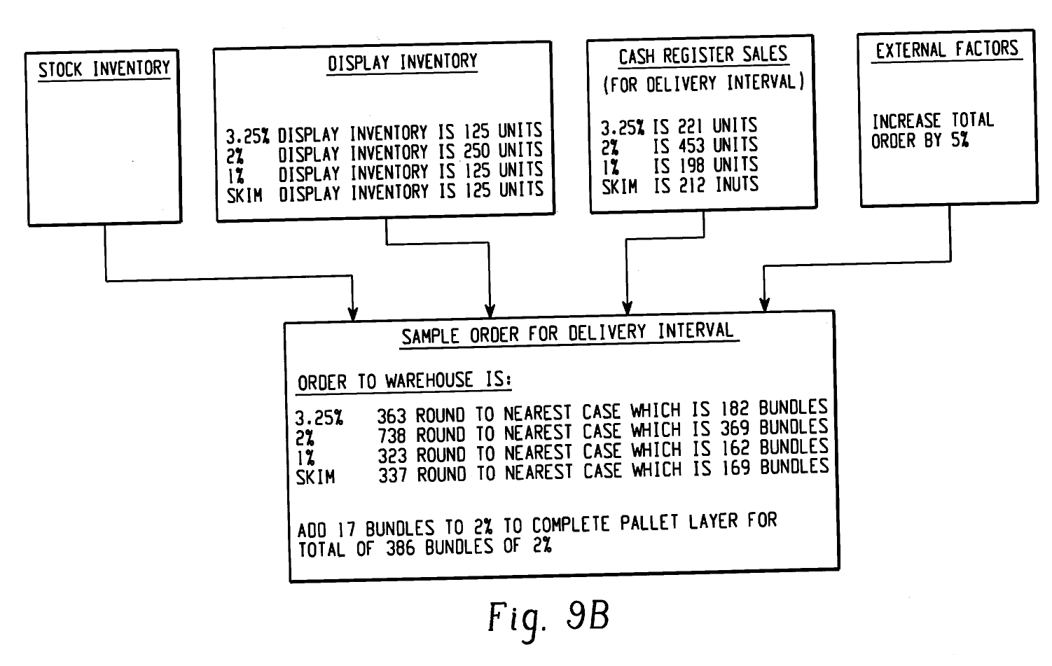

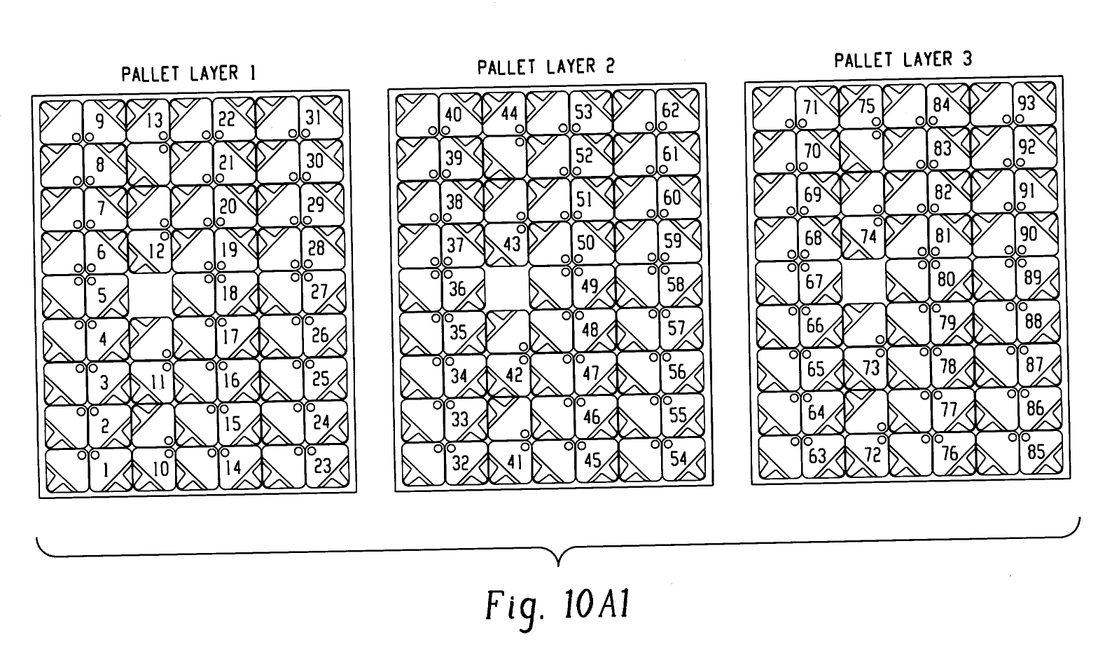

The application of the present invention is further explained by examination of the customer requirements and the information generated at the customer level as exemplified in FIG. 9 (FIGS. 9A and 9B). FIG. 9A illustrates a typical display 930 in a retail store and the factors affecting replenishment. The display consists of 50% to 60% of the available space for the large volume items that constitute approximately 60% to 70% of the dairy product sales. These products typically include the four or five major milk items represented by display portion 932. The remainder 934 of the display is made up of approximately one hundred other items that constitute the remaining 30% or 40% of the sales. The order fulfillment criteria are the available display space, the delivery frequency, the level of cash register sales, and non-display inventory and certain external factors such as weather, time of month, etc. These factors may translate into an order to the supplier, manufacturer or warehouse as indicated. This example states that the order fulfillment process at store level requires three hundred sixty three units of 3.25% product. Because there are two units in a bundle, the order is rounded up to three hundred sixty four units or one hundred eighty two bundles. Similarly, the 2% order became three hundred sixty nine bundles, the 1% order is one hundred sixty two bundles and the skim or nonfat milk order is one hundred sixty nine bundles.

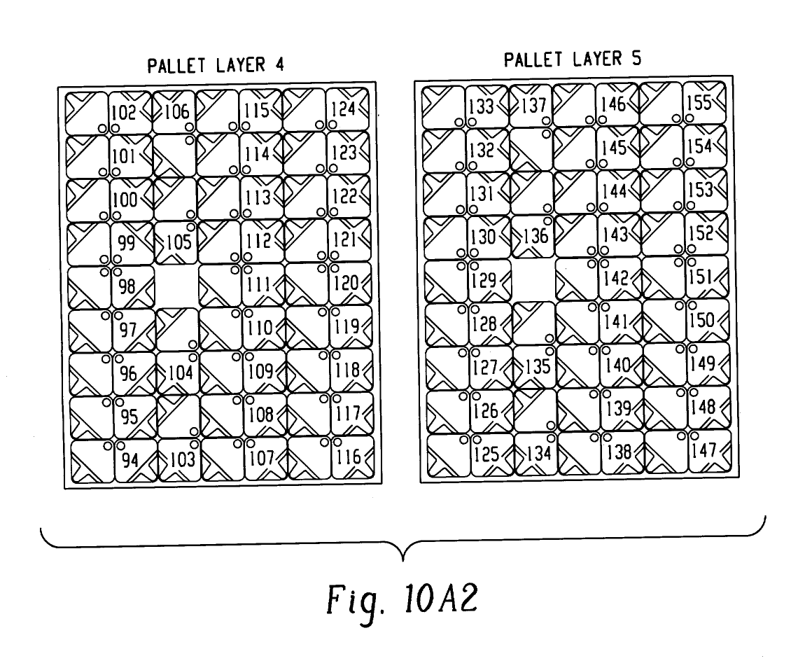

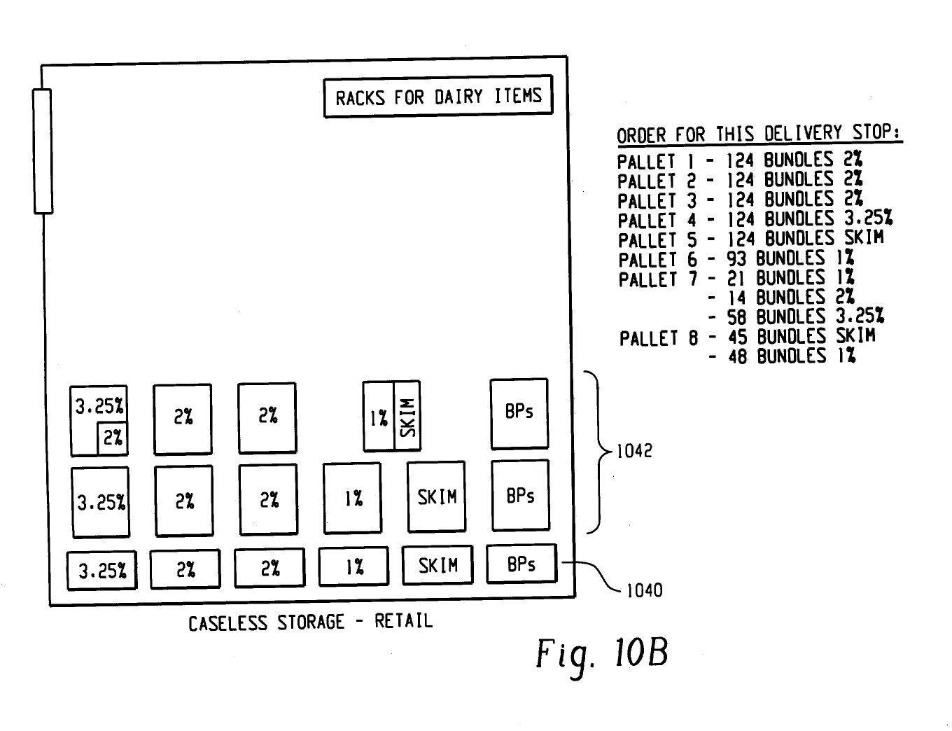

FIG. 10 illustrates the transformation that would take place as a result of the customer requirements. In this case, the palletizing requirement is only that full layers be made on a pallet. As a consequence and since a standard 40×48 grocery pallet will allow for sixty two units or thirty one bundles on a layer, the total number of layers is calculated as follows:

3.25%—one hundred eighty two (182) bundles

2%—three hundred sixty nine (369) bundles

1%—one hundred sixty two (162) bundles

Skim—one hundred sixty nine (169) bundles

Total—eight hundred eighty two (882) bundles.

This equates to 882/31=28.45 layers. This further suggests that the total layers sent will be 29, as we would choose to round up. For this example, we will add the 2% only. Therefore, the dairy may ship seventeen (17) additional bundles of 2% milk.

The twenty nine (29) layer example could be shipped in seven (7)-four (4) layer pallets and one (1) layer pallet. It could also be shipped as five (5)-five (5) layer pallets and a four (4) layer pallet, or as five (5)-four (4) layer pallets and three (3)-three (3) layer pallets.

FIG. 10A shows the five individual layers for a pallet. With thirty one (31) bundles per layer, there are one hundred fifty five (155) individual bundle locations on the pallet. Each can be filled with an individual product based on the customer requirements.

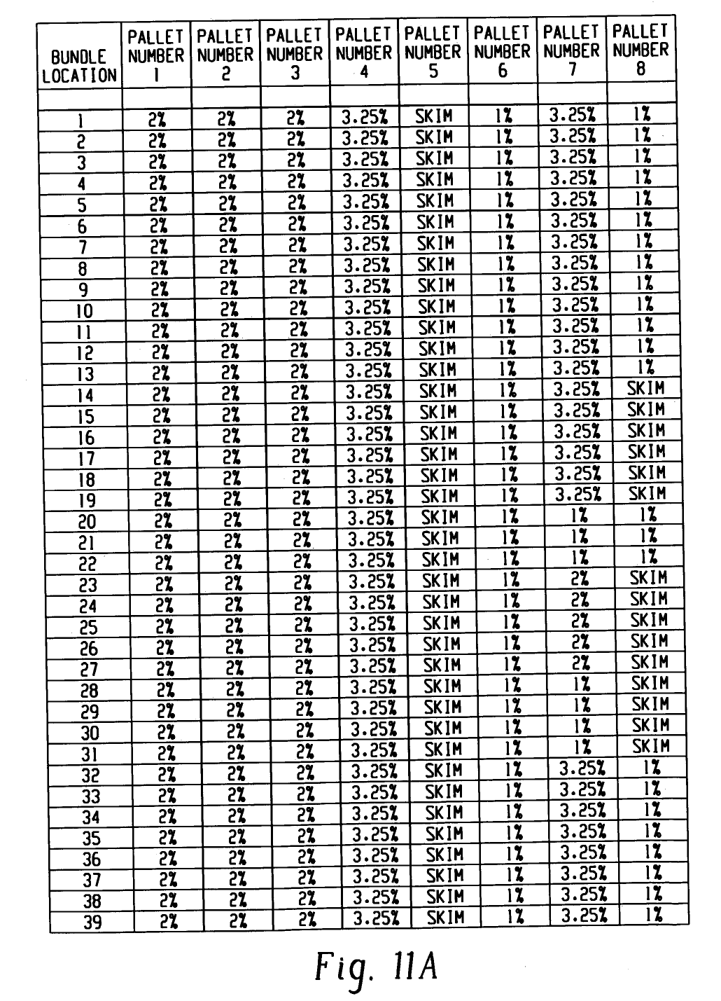

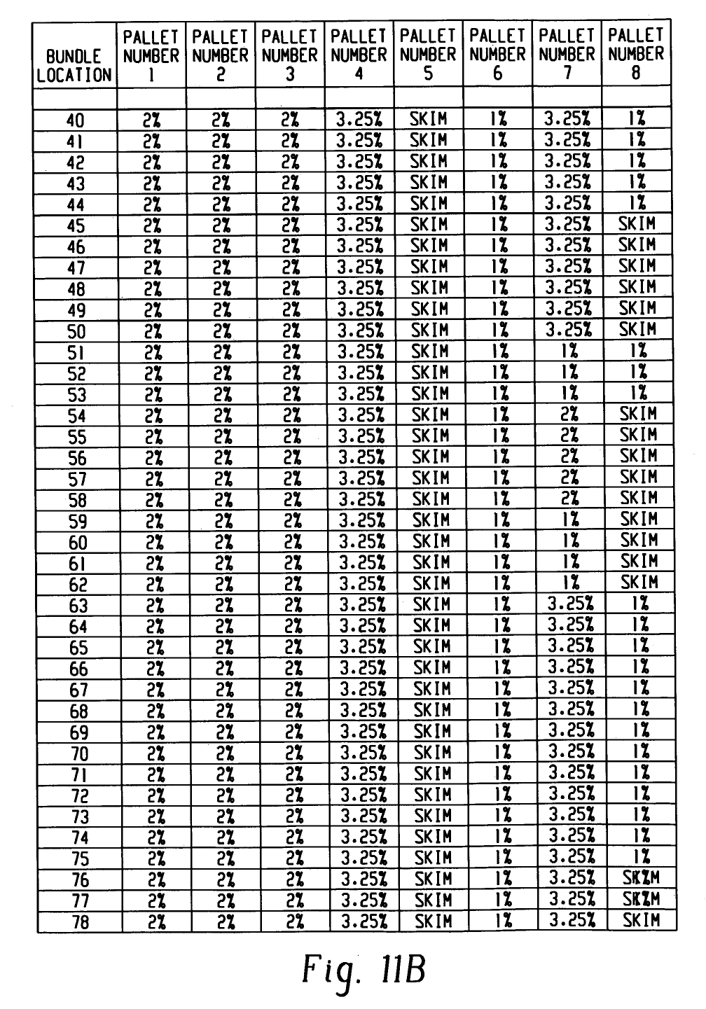

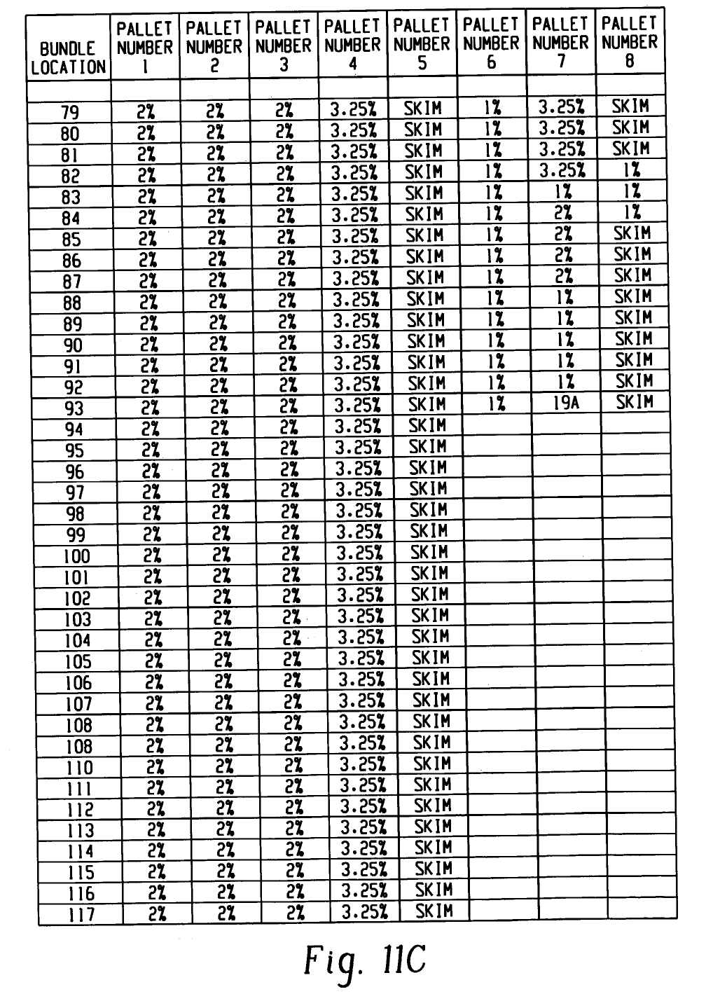

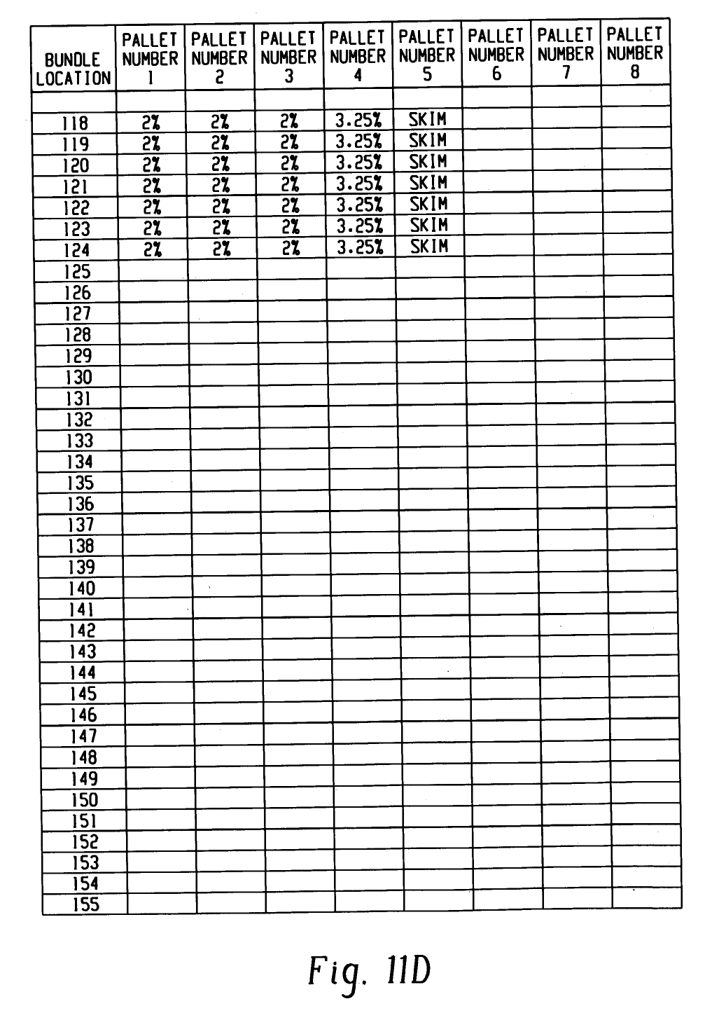

FIG. 10B also shows a plan view of the retail stores display 1040 and the reserve storage 1042 behind the display. Based on this layout the product should be palletized so proper product can be located directly behind the product being displayed to assure maximum efficiency at the store level. The fact that the product is shipped in a “caseless” manner means that no space has to be reserved to maneuver empty cases and that no lost motion is required on the part of the store's employee during the re-stocking process. With this consideration, the pallets could be loaded as indicated in the table shown in FIG. 11.

This configuration could also be changed to accommodate other distribution constraints. An example would be to ship other products on top of the pallets of milk. This is practical due to the caseless nature and strength of the caseless bottle as shown and described in commonly owned, co-pending application Ser. No. 09/114/244, filed Jun. 29, 1998, the details of which are incorporated herein by reference. Based on this, the twenty-nine (29) layers may become nine (9)-three (3) layer pallets and one (1)-two (2) layer pallet. The distribution of products per pallet would obviously change to accommodate the total needs.

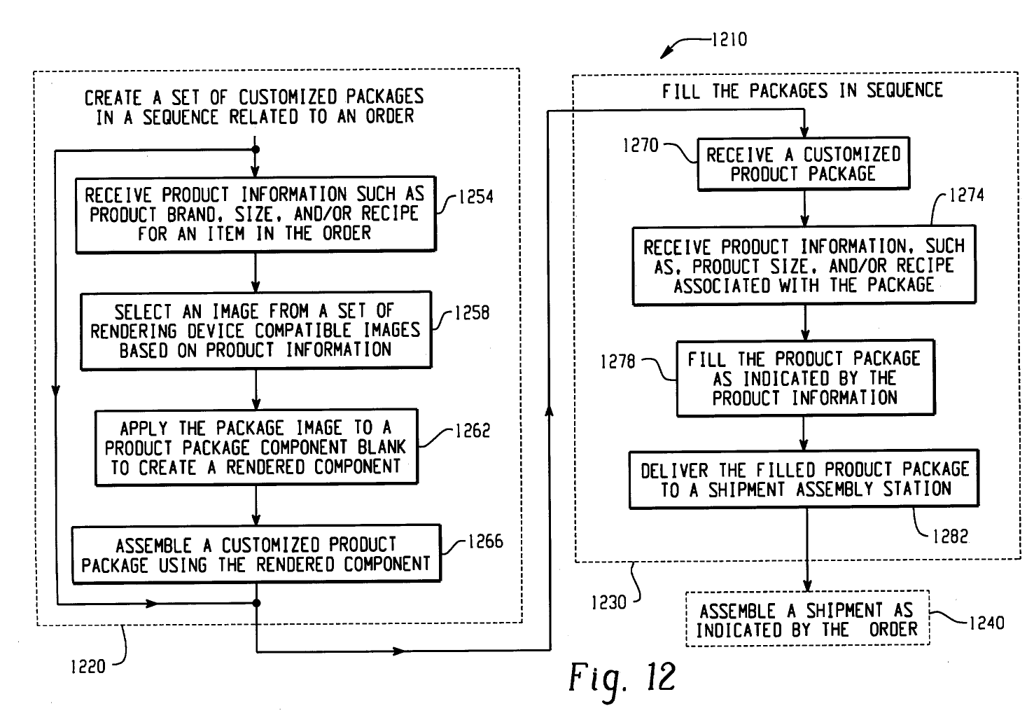

As a summary, FIG. 12 outlines a high-speed method 1210 for producing products in response to the receipt of an order. The method includes a custom package creation step 1220, a package filling step 1230, and a shipment assembly step 1240.

In the custom package creation step 1220, a set of packages is created that corresponds to items in the order. Additionally, the packages are created in a sequence that is indicated by the order. For example, in a product information receiving step 1254, an item from the order is identified as to, for example, the product brand, the size or amount of product included in the item, and/or an ingredient list (recipe) for making the item. For instance, an item is identified as “Brand X, 2% milk,” in a one gallon jug. Alternatively, a product may be identified as a particular kind of blended wine or color and grade or paint. Based on this identification, a product package image is selected from a repository of rendering device compatible images in an image selection step 1258. For example, a “Brand X” jug label including a 2% milk indication and a one-gallon marking is selected. The image may also include machine-readable identification markings. For example, the image includes a bar code indicating that the package contains one gallon of 2% mail. In an image application step 1262, the selected image is applied to a package component blank. For example, the image is printed on a blank milk jug label. Alternatively, the image is applied directly on a package. Once the im age is applied to the packaging component blank to create a rendered component, the rendered component is assembled into a custom product package in a package assembly step 1266. Once a package is completed, it can be passed onto, for example, a filling station where it is filled in filling step 1230. Of course, additional packages can be created while some packages are being filled. The filling station receives the package in a package reception step 1270 and product information in a product information reception step 1274. For example, the product information is delivered from a production line supervisory system. Exemplary product information includes the amount of product to be delivered to the package and ingredients for creating the product. For example, an amount of 3.25% milk and an amount of skim milk are indicated for creating a gallon of 2% milk. However, preferably the product information is read directly from the custom package. For example, a scanner reads a bar code that is included in the custom package image. The bar code identifies the package as being for a gallon of 2% milk and the filling station accesses a predetermined recipe for creating 2% milk. However the appropriate amounts are determined, the filing station meters out appropriate amounts of product constituents in a package filling step 1278. When the package is full it is sealed. The sealed container is delivered to a shipping station in a shipping station delivery step 1282. In the shipment assembly step 1240, the product packages are arranged in a shipment device such as, for example, a pallet. The shipment is arranged for the convenience of the customer. The product is preferably arranged so that product can be placed in a display case with as few steps as possible. The arrangement of the shipment is facilitated by the order in which the product is delivered from the filling station. Product is delivered from the filling station in the order in which the filling station receives empty custom packages. The custom packages are delivered to the filling station in the order in which they are created. Custom packages are created in the sequence dictated by the supervisory system controlling the product package customizer. The supervisory system determines the proper sequence of packages from the received customer order. Optionally, the supervisory system compares a customer order with predetermined customer layout information in order to generate an appropriate custom package sequence.

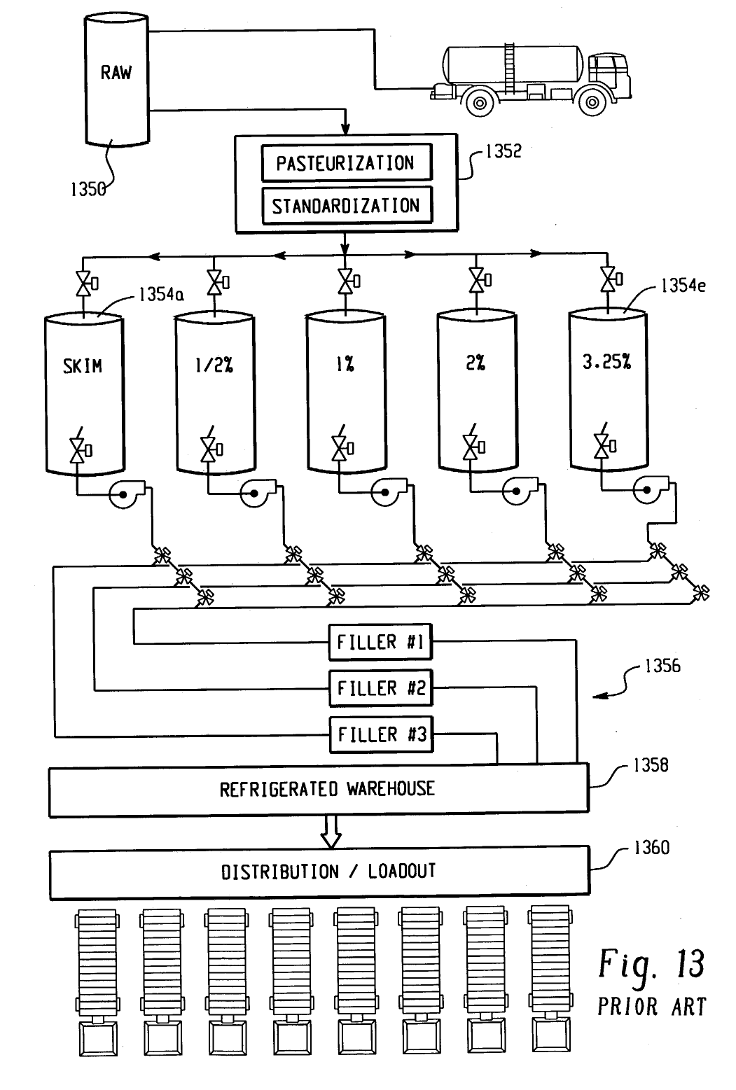

As indicated above in references to FIGS. 10 and 11, the present invention has the ability to flexibly fulfill customer requirements based on optimal scenarios. A common feature among the full service dairy manufacturers and distributors is that approximately 60% of their daily throughput is the white milk described as 3.25%, 2%, 1%, 12% and skim milk. It is also true that these manufacturers create large batches of these white milk products. They currently fulfill customer requirements through processes similar to, if not exactly as shown schematically in FIG. 13. This process begins with raw milk being received and temporarily stored in silo tanks 1350. Raw milk will be withdrawn through the raw silo tanks 1350, pasteurized and standardized at 1352 into large vessels 1354a-e to hold each type of pasteurized and standardized product (3.25%, 2%, 1%, etc.). Filling machines 1356 will then draw from the various pasteurized product tanks, one product at a time, and put a specific type of milk into a specific pre-labeled bottle (i.e., 2% milk into brand X package). These containers are then put into returnable cases (or transport devices) or corrugated one-way shippers. The product is then sent to a storage or distribution center type of system 1358. The product is collected from storage 1358 based on orders from customers. It is picked, selected, accumulated or somehow assembled into a load that will be put onto a delivery vehicle with a usual mission of only delivering the dairy products from that particular dairy warehouse or distributor as represented at 1360.

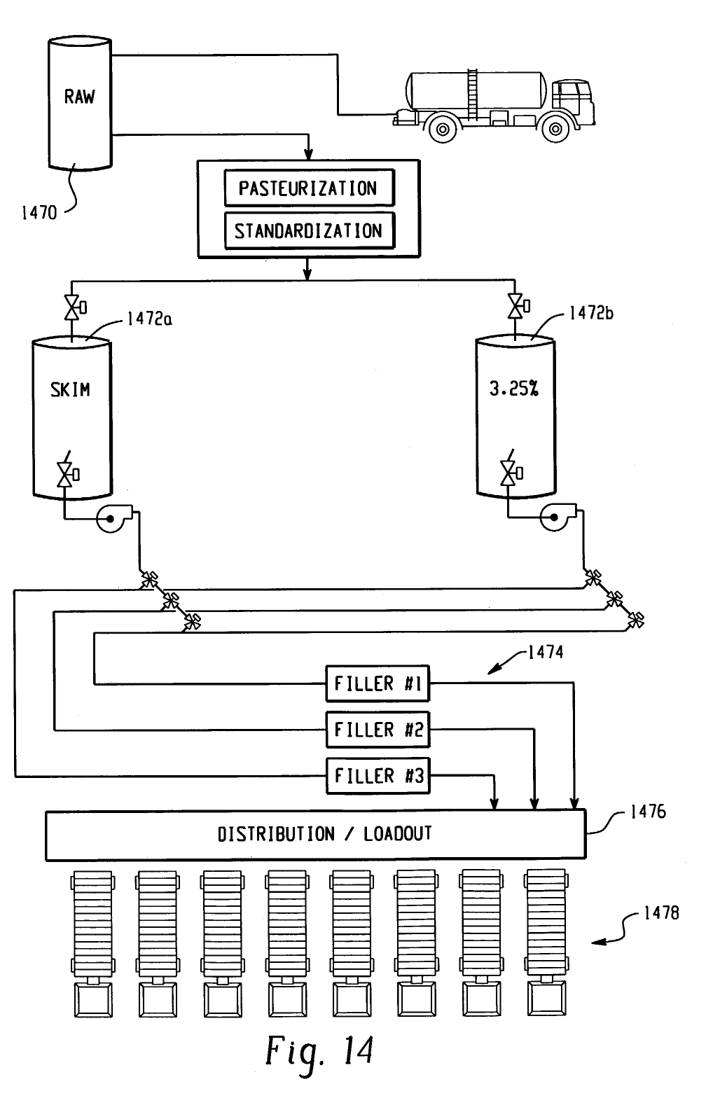

The present invention provides a revised approach for the 60% to 70% of the volume of products typically handled by the full service manufacturers and provides an improved approach to the manufacturers who are virtually only white milk manufacturers today. FIG. 14 shows a schematic of the revised manufacturing process. Raw milk is received and temporarily stored in raw storage vessels 1470. Raw milk is drawn from the vessels and is processed into a nonfat and a high fat components 1472a and 1472b only. These two components are blended together at 1474 based on customer and delivery needs, palletized and directed to a load out facility 1476 in a manner synchronized with the proper loading time of delivery vehicle(s) 1478.

The present invention, as applied and described above provides an improved approach to the delivery of milk and other refrigerated products associated with the grocery store business.

FIG. 15 illustrates the current method of bringing milk in its raw state from the original source (the farm), to the grocery store or the final retail businesses that makes the product available to the consumer. The milk is produced on a farm 1480 and shipped via insulated tank truck to the dairy 1582, where it is processed in the conventional manner as shown and described above. The product is then shipped directly to the store in certain instances as represented by numeral 1584 in, for example, a truck delivering only dairy products from the dairy. Alternatively, milk is also shipped as represented by numeral 1586 to various distributors or warehouses 1588, where it is unloaded from the delivery truck 1586, sorted, stocked, and re-loaded and re-shipped, to the final retailer 1590.

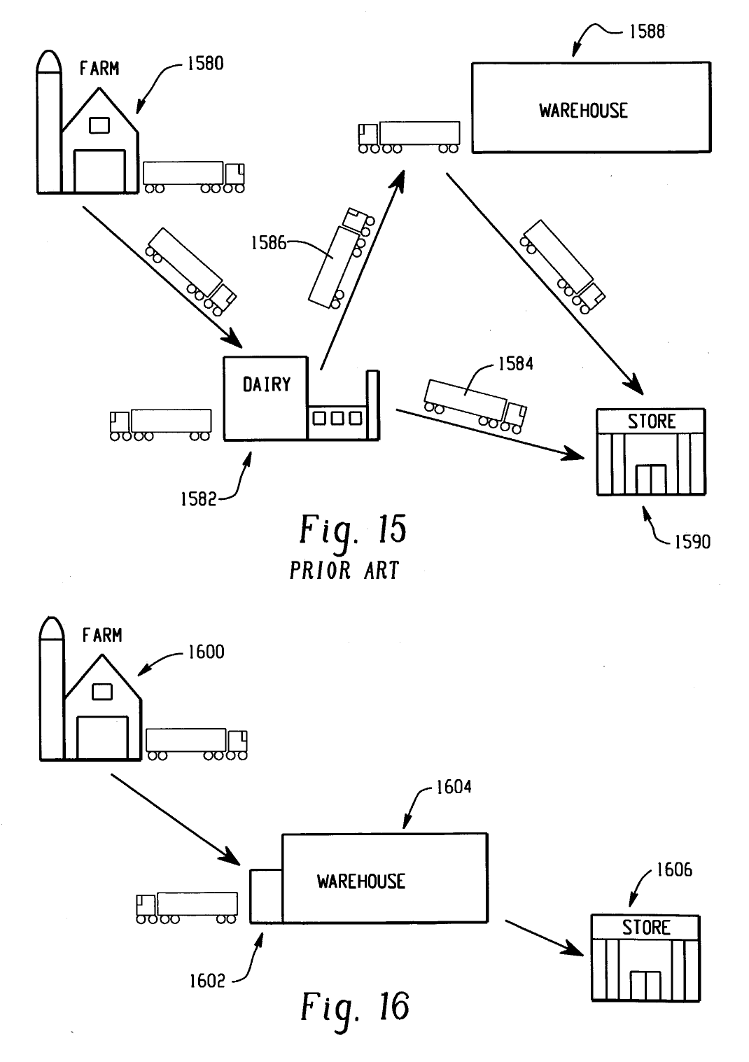

The present invention allows and promotes the use of an improved approach as illustrated in FIG. 16. This approach provides for the direct transfer of the raw product from a source 1600, or farm, to a micro dairy 1602 associated with a warehouse or primary distribution supply 1604 to the store or food retailers 1606. This allows the advantages of the flexible high-speed production line (or filling system) to be applied to the warehouse distribution network. The use of the structural caseless package as described in the commonly owned, co-pending application identified above and the flexible filling system shown and described herein permits the integration of traditional warehouse products with the white milk products constituting maximized delivery efficiency. This is realized based upon the low maximum weight and volume cube in a warehouse delivery vehicle and on the improved frequency of delivery for the retailer. For example, low volume milk deliveries can now be combined with regular grocery deliveries. This provides two advantages. Fewer delivery miles are driven per gallon of mil, thereby reducing distribution costs. Milk is delivered from the micro-dairy 1602 associated with the warehouse 1604 along with other grocery items distributed by the warehouse, thereby allowing for more frequent and therefore fresher deliveries of milk.

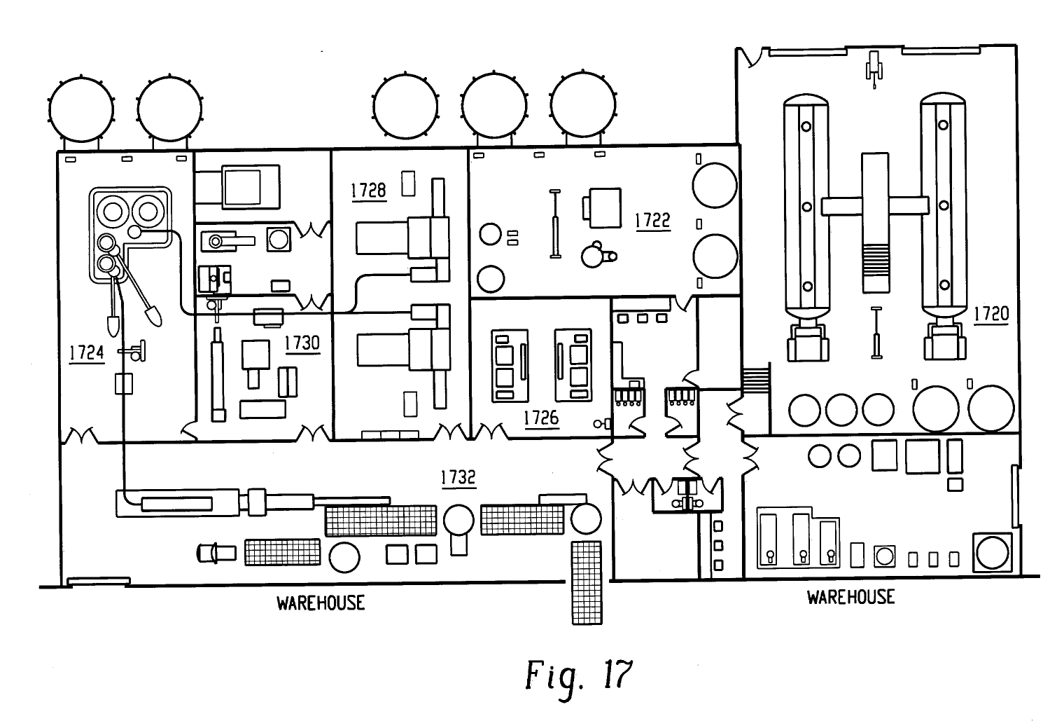

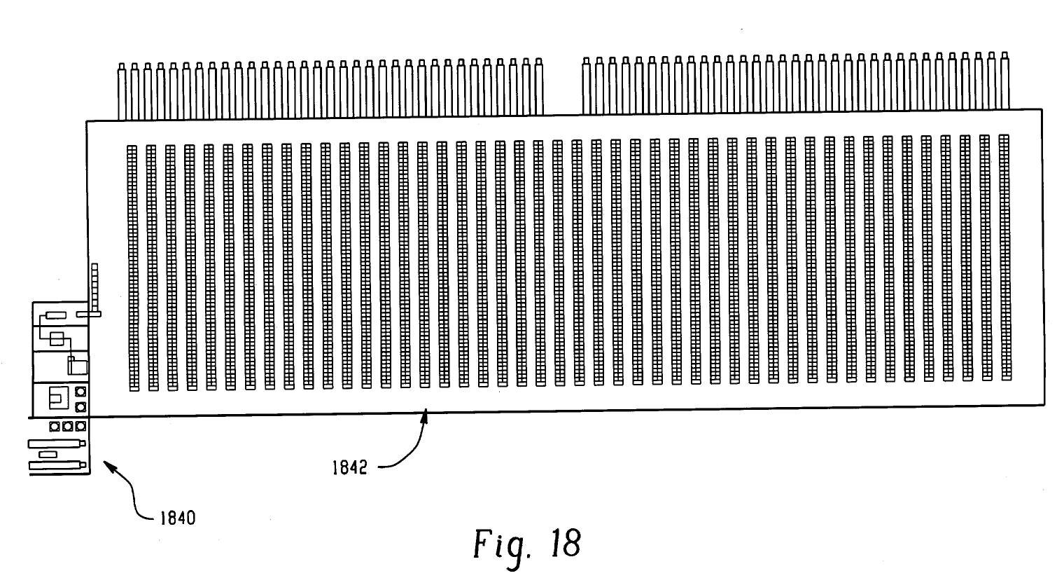

The current invention further allows for the development of an integrated micro dairy facility to be operated in conjunction with a warehouse or distributor of even smaller proportions as compared to current industry standards. FIG. 17 illustrates such a facility capable of successfully completing all functions as needed for the warehouse or distribution facility. For example, a receiving bay 1720 receives the raw milk into the micro dairy facility. The raw milk is processed at a raw milk treatment station 1722. This provides the two grades of milk, which in the preferred embodiment are 3.25% and skim. The processed milk is stored and subsequently forwarded to filling station 1724 where it is easily conveyed to the filler as described above. Control room 1726 handles or coordinates the actions of the micro dairy including receiving data regarding raw milk input, processing control, production of various sized containers or bottles at a blow molding station 1728, labeling at station module 1730, filling at 1724, and palletizing and shipping at 1732.

FIG. 18 further shows a typical application of this micro dairy facility 1840 as a small addition to a typical warehouse 1842 that would be distributing product to a retail grocery outlet. As noted, this concept applies to both small and large distribution applications.

It can be seen that there are many advantages for manufacturers and consumers in this approach. Processing of different milk grades is reduced down to two types: skim and 3.25%. The need for large storage tanks for the different milk grades is likewise reduced. Since the filler bowls will each have only one product in them for the entire production day, changeovers are eliminated, thereby reducing labor and waste. Finally, since the filler is completely responsive to the needs of the distribution department, load out is simplified, and the required warehouse space is vastly reduced. Overall, the entire manufacturing plant process is greatly simplified, is reduced in size, and reduced in complexity.

Accompanying this concept, a high hygiene and highly reliable filler is anticipated. A filling system includes the filler and the high-speed label printing process described. This system has the following attributes:

accurate filling of two or more components into the same container to get variable attributes from the flexible process;

the ability to change product without loss of efficiency. In other words, a system able to change without interrupting or halting production;

the ability to produce product accurately and exactly as customer requires;

the ability to integrate and interpret commands from the control system based on customer requirements into labeling and filling commands to exactly meet the customer expectations; and

the ability to match the variable demands of load out processes without depending on excessive inventories. This surplus drastically reduces storage space compared to conventional manufacturing techniques.

The invention has been described with respect to the preferred embodiments. Modifications and alterations will occur to others upon a reading and understanding of this specification. For example, the invention can be applied to many other product bottling or packaging operations. For instance, the invention may be beneficially applied to the packaging of paint, drugs, paper products, hygiene products, wine, and powdered products such as cake mixes, cements, and concretes. In short, the invention is useful wherever the same product is sold under a variety or brands, or wherever products are produced by blending or mixing ingredients. Additionally, the invention is useful where very short production runs are made under custom packaging or labeling. For example, a wine producer may use the invention to efficiently label as few as a single bottle of wine as “Bottled Especially for John Doe,” thereby creating a vanity or novelty wine market. It is intended to include all such modifications and alterations in so far as they come within the scope of the appended claims or the equivalents thereof

What is claimed is:

1. A high-speed customer fulfillment, product production line comprising:
a high-speed packaging customizer comprising:
a rendering device operative to produce customized product packaging components;
a rendering device compatible electronic image storage system operative to store custom product package image information in a form that is most compatible with the rendering device, and
a rendering controller operative to select particular custom product image information from the rendering device compatible electronic storage system, based on information delivered from at least one external source, and deliver the selected custom product image information to the rendering device.

2. The high-speed, customer fulfillment, product production line of claim 1 wherein the rendering device compatible electronic image storage system comprises a rasterized image storage system.

3. The high-speed, customer fulfillment, product production line of claim 1 wherein the rendering device comprises an ink based label printer.

4. The high-speed, customer fulfillment, product production line of claim 1 wherein the rendering device comprises a toner based label printer.

5. The high-speed, customer fulfillment, product production line of claim 1 further comprising:
a supervisory system operative to receive information from a plurality of sources and make product package filling decisions based on the received information and to send control signals regarding the product package filling decisions; and
a package filler operative to fill a customized product package as directed by signals received from the supervisory system.

6. The high-speed, customer fulfillment, product production line of claim 5 wherein the custom product package image information includes machine readable product identification information, the supervisory system comprising:
a scanner operative to read the machine readable product identification information from a customized product package, the product identification information being used to make package filling decisions.

7. The high-speed, customer fulfillment, product production line of claim 5 wherein the product filler further comprises:
a blender operative to blend at least two product components in a ratio as directed by the supervisory system.

8. The high-speed, customer fulfillment, product production line of claim 5 wherein the supervisory system comprises:
a sensor operative to measure an amount of product delivered to a product package and report amount information to the supervisory system.

9. The high-speed customer fulfillment, product production line of claim 5 further comprising:
a receiving station for receiving raw milk into the plant;
a heat treatment station for processing the raw milk into only two grades of processed milk, and
a control station operative to receive customer order information and sending signals based on the order information to the rendering controller.

10. The high-speed customer fulfillment, product production line of claim 5 further comprising:
a storage system operative to store only two grades of processed milk;
a delivery system operative to separately deliver the two grades of milk to the package filler, and
a control station operative to receive customer order information and send signals based on the order information to the supervisory system.

11. The high-speed customer fulfillment, product production line of claim 5 wherein the package filler comprises:
a filling station operatively associated with the two grades of processed milk capable of blending at least four types of milk in individual containers from the two grades of processed milk in response to the control signals from the supervisory system.

12. The high-speed customer fulfillment, product production line of claim 5 further comprising:
a shipping station operative to receive custom packaged products from the high speed customer fulfillment, product production line and assemble an entire customer order as it comes off the production line.

13. A high-speed method for producing products in response to the receipt of an order, the method comprising:
creating a set of customized product packages in a sequence as indicated by the order;
filling the packages in sequence as indicated by the order;
assembling a shipment corresponding to the order as the sequence of filled product packages is output from a production line.

14. The high-speed method for producing products of claim 13 wherein the step of creating a set of customized product packages comprises:
receiving a product brand designation for an ordered item;
selecting a custom product package image, from a set of rendering device compatible custom product package image descriptions, based on the product brand designation;
rendering the selected custom product package image onto a package component blank to create a rendered component;
assembling a custom product package with the rendered component; and
repeating these steps for a next item in the order, as necessary, to create custom packages for all the items in the order.

15. The high-speed method for producing products of claim 13 wherein the step of creating a set of customized product packages comprises:
receiving a product amount or size designation for an ordered item;
selecting a custom product package image, from a set of rendering device compatible custom product package image descriptions, based on the product amount or size designation;
rendering the selected custom product package image onto a package component blank to create a rendered component;
assembling a custom product package with the rendered component; and
repeating these steps for a next item in the order, as necessary, to create custom packages for all the items in the order.

16. The high-speed method for producing products of claim 13 wherein the step of creating a set of customized product packages comprises:
receiving a product recipe designation for an ordered item;
selecting a custom product package image, from a set of rendering device compatible custom product package image descriptions, based on the product recipe designation;
rendering the selected custom product package image onto a package component blank to create a rendered component;
assembling a custom product package with the rendered component; and
repeating these steps for a next item in the order, as necessary, to create custom packages for all the items in the order.

17. The high-speed method for producing products of claim 13 wherein the step of filling the set of customized product packages comprises:
receiving the customized package for the ordered item;
receiving a product amount or size designation for the ordered item;
filling the received customized package as indicated by the amount or size designation.

18. The high-speed method for producing products of claim 13 wherein the step of filling the set of customized product packages comprises:
receiving the customized package for the ordered item;
receiving a product recipe designation for the ordered item;
filling the received customized package as indicated by the received recipe designation.

19. The high-speed method for producing products of claim 17 wherein the step of receiving a product amount or size designation comprises:
scanning the custom package for a product identification designation; and
using the product identification designation to retrieve an amount or size designation.

20. The high-speed method for producing products of claim 18 wherein the step of receiving a product recipe designation comprises:
scanning the custom package for a product identification designation; and
using the product identification designation to retrieve a product recipe designation.

21. A packaging line comprising:
a supervisory device operative to select a custom product package production sequence based on an order and to send control information to packaging line components to produce custom product packages in the selected sequence;
a packaging component supply operative to provide package blanks;
a packaging customizer operative to receive package blanks from the packaging component supply and to produce customized product packages, the packaging customizer comprising:
a rendering device operative to customize packaging components based on received rendering information;
a rendering device compatible, electronic data storage system operative to store custom product package rendering information in a form, that is most compatible with the rendering device, and
a rendering controller operative to select particular custom product rendering information from the rendering device compatible, electronic storage system, based on the selected sequence received from the supervisory system, and to deliver the selected custom product rendering information to the rendering device.

22. The packaging line of claim 21 wherein the supervisory system is additionally operative to select a production sequence based on a desired shipment layout, the packaging line further comprising:
a shipping station operative to receive product packages in the selected sequence, wherein a product shipment is efficiently assembled because of the selected sequence.

23. The packaging line of claim 21, the packaging line further comprising:
a filling station operative to receive customized product packages and fill the product packages according to filling instructions.

24. The packaging line of claim 23, the filling station comprising:
a scanner operative to recognize identification information on the customized package; and
a recipe database operative to associate the identification information with package filling instructions.

25. The packaging line of claim 23 further comprising:
a first product component source operative to provide a first product component to the filling station.

26. The packaging line of claim 25 further comprising:
a second product component source operative to provide a second product component to the filling station wherein the filling station is additionally operative to fill the customized product packages with a blend of the first product component and the second product package.

27. The packaging line of claim 26 wherein the first product component supply is operative to supply a first grade of milk to the filling station.

28. The packaging line of claim 27 wherein the second product component supply is operative to supply a second grade of milk to the filling station.
